(19) United States
(12) Patent Application Publication
(10) Pub. No.: US 2023/0284638 A1
(43) Pub. Date: Sep. 14, 2023

(54) DEER FIELD DRESSING DEVICE

(71) Applicant: Buck Spreader, LLC, Rexford, NY (US)

(72) Inventor: Rolland Gibbs, Saratoga, NY (US)

(21) Appl. No.: 17/693,337

(22) Filed: Mar. 12, 2022

(51) Int. Cl. A22C 17/02; A01M 31/00

(52) U.S. Cl. CPC A22C 17/02; A01M 31/00

(57) ABSTRACT

The present invention is directed to an improved field dressing device for propping apart the hind legs of a dear for field dressing purposes.

### TECHNICAL FIELD

The present invention relates to the field of deer hunting, and more particularly to apparatuses for field dressing a deer after harvesting.

### BACKGROUND OF THE INVENTION

After a deer kill, the internal organs of the deer must be removed in the field as soon as possible. It is desirable to spread the hind legs of the deer carcass to provide the hunter with access to the belly and other anatomy for the dressing process. One can prop the hind legs open with a branch or tie the legs off to trees, but there are inherent limitations associated with these methods. There is a need for a better way to prop open the hind legs. Prior art discloses apparatuses used to expand the rib cage of an animal after the animal has been field dressed so that the carcass may cool faster, one of which has length adjustable at fixed increments and the other having fixed length with fixed forked braces. Other prior art discloses an animal hanging gambrel for hanging a dressed deer and having length adjustable at fixed increments.

There is a need for a rugged, light weight and compact device with continuously adjustable length for propping apart a deer's hind legs during the field dressing process that is easy to pack into a carrying container of compartment, to carry, to unpack and to use in the field. The present invention is directed to an improved deer field dressing device that fills this need.

### SUMMARY OF THE INVENTION

In a first aspect, the present invention provides a deer field dressing device for propping apart the hind legs of a deer carcass, comprising: a telescopic extension pole having a first end and a second end; a first fork attached to the first end, said first fork comprising a first prong and second prong for receiving a deer carcass leg between the first and second prongs; a second fork attached to the second end, said second fork comprising a third prong and fourth prong for receiving a deer carcass leg between the third and fourth prongs.

In a second aspect, the present invention provides a method of propping apart the hind legs of a deer carcass for field dressing purposes, comprising the steps of: disposing between the hind legs of the carcass a telescopic extension pole having a first end, a second end, a releasable friction lock, and an adjustable length adjustable to any length over a range from a fully retracted length to a fully extended length; engage a first end of the device with one leg; engage a second end the device with the other leg; adjusting the length to any desired length in the range of lengths; and activating the releasable friction lock to releasably fix the length of the extension pole.

### BRIEF DESCRIPTION OF THE DRAWINGS

The subject matter that is regarded as the invention is particularly pointed out and distinctly claimed in the concluding portion of the specification. The invention, however, may be best understood by reference to the following detailed description of various embodiments and the accompanying drawings in which:

FIG. 1 is a pictorial view of one embodiment of the field dressing device of the present invention in a fully extended configuration;

FIG. 2 is the same as FIG. 1 except the left-side fork is rotated 90° about a longitudinal axis;

FIG. 3 is the same as FIG. 1 except the left-side fork is rotated 180° about a longitudinal axis;

FIG. 4 is the same as FIG. 1 except the left-side fork is rotated 270° about a longitudinal axis;

FIG. 5 is a pictorial view of the device of FIG. 1 in a fully retracted configuration;

FIG. 6 is the same as FIG. 5 except the left-side fork is rotated 90° about a longitudinal axis;

FIG. 7 is the same as FIG. 5 except the left-side fork is rotated 180° about a longitudinal axis;

FIG. 8 is the same as FIG. 5 except the left-side fork is rotated 270° about a longitudinal axis;

FIG. 9 is a pictorial view of a device of the present invention deployed in the field propping prop apart the legs of a deer carcass;

FIG. 10 is a close-up pictorial view of the left end portion of the device of FIG. 1;

FIG. 11 is an exploded assembly view of the fork, end plug and pole portion shown in FIG. 10;

FIG. 12 is a close-up pictorial view of the right end portion of the device of FIG. 1;

FIG. 13 is an exploded assembly view of the fork, end plug and pole portion shown in FIG. 12;

FIG. 14 is a side view of the end plug of FIG. 11;

FIG. 15 is a top view of the end plug of FIG. 14;

FIG. 16 is a bottom view of the end plug of FIG. 14;

FIG. 17 is a section view on section plane 17-17 of the end plug of FIG. 14;

FIG. 18 is an end view of the fork of FIG. 11;

FIG. 19 is right side view of the fork of FIG. 18; and

FIG. 20 is a pictorial view of the fork of FIG. 18 with a portion of the surface coating cut away;

FIG. 21 is a pictorial view of the portion of the device shown in FIG. 10 with the fork partially unthreaded from the end plug;

FIG. 22 is a pictorial view of the portion of the device shown in FIG. 21 with the fork unthreaded another quarter-turn;

FIG. 23 is a pictorial view of the portion of the device shown in FIG. 21 with the fork unthreaded another half-turn;

FIG. 24 is a pictorial view of the portion of the device shown in FIG. 21 with the fork unthreaded another three-quarter-turn;

FIG. 25 is a pictorial exploded assembly view of a lock 51 of the present invention;

FIG. 26 is a side view of a lock of the present invention in the unlocked state with some parts in cross section and with curved arrows indicating twisting tube 80 to engage the lock; and

FIG. 27 is the same view as FIG. 26, but with the lock in the locked state, with arrows indicating collar 53 pressing against the inside of a tube.

### DETAILED DESCRIPTION OF THE INVENTION

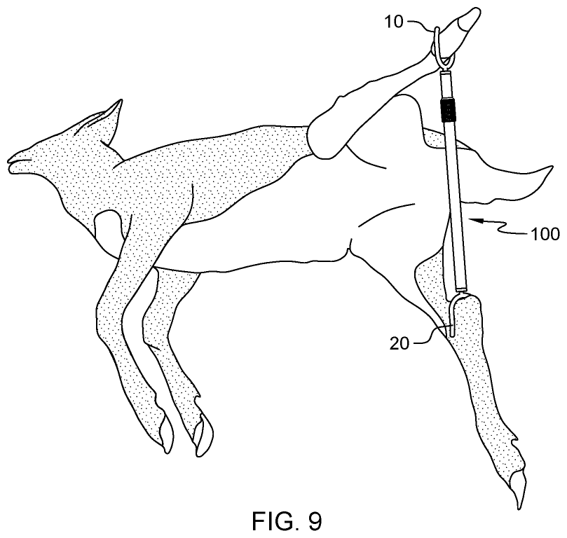

With reference to FIG. 9, deer field dressing device 100 of the present invention is shown in operation propping apart the hind legs of a deer carcass to expose the belly and other anatomy for easier access by a deer hunter to field dress the deer. Forks 10 and 20 each engage a hind leg.

With reference to FIG. 1, dear field dressing device 100 may comprise telescopic pole 50, knurl 70, and forks 10 and 20. Pole 50 comprises pole segments 80 and 90. Knurl 70 may be affixed to pole segment 90. Fork 10 is attached to and extends outwardly from the end of pole segment 80 and fork 20 is attached to and extends outwardly from the end of pole segment 90.

Pole segment 90 is hollow and may receive pole segment 80 slidingly within its hollow core so that the length of the device may be adjusted telescopically. In the embodiment shown in FIG. 1, pole segment 90 comprises a cylindrical hollow tube having an inside diameter and pole segment 80 comprises a cylindrical outer surface with an outside diameter smaller than said inside diameter of pole 90.

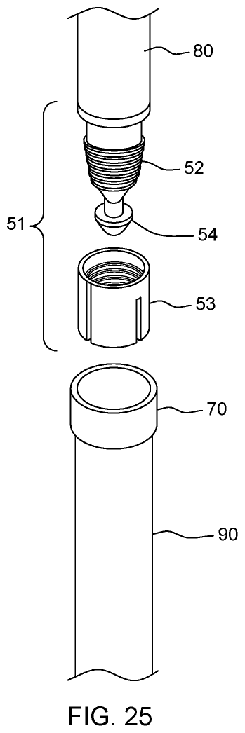

Pole segments 80 and 90 may be locked into position with a lock 51 (see a preferred lock embodiment in FIGS. 25-27).

Telescopic pole 50, comprising pole segments 80 and 90 and lock 51, may comprise conventional commercially available technology commonly known in the art for telescopic tubular poles. Examples of such conventional, commonly known technology are offered commercially by Testrite Instrument Co. and disclosed on its website https://www.testrite.com and in its brochure O.E.M. Telescopic Aluminum Tube Assemblies available online at https://www.testrite.com/pdf/598214de6e34f-Testrite-OEM-Brochure.pdf.

Various types of locks are well known in the art, such as cam, clutch, split collar, spring button, snap, set screw, and retaining pin locks. “Cam” telescopic tube locks are mechanisms located entirely inside the tubes and are engaged and disengaged by twisting the pole segments about their longitudinal axes relative to one another. Twisting one way engages the cam lock to hold the segments in fixed relation to one another, and twisting the opposite way disengages the lock to allow the segments to slide longitudinally relative to one another. One type of cam lock comprises eccentrically connected parts that misalign when the tubes are rotated, which misalignment causes the parts to press against the inside of the outer tube. An example of an eccentric cam lock is disclosed in U.S. Pat. No. 3,833,012 to McAllister, the entire subject matter of which is incorporated herein by reference.

Another type of cam lock comprises a cam that rotates when the tubes are twisted, which rotation causes the cam to presses against a shoe of nonuniform thickness which presses the shoe against the inside surface of the outer tube. An example of cam-and-shoe cam lock 51 is disclosed in U.S. Pat. No. 5,460,458 to Caceres, the entire subject matter of which is incorporated herein by reference.

Screw and collar locks are another type of lock that can be considered in a common category with cam locks (herein “twist locks” category) because they are activated by twisting the tube segments and the lock mechanism is entirely inside the tubes. Examples of screw and collar locks 51 are disclosed in U.S. Pat. No. 6,745,909 to Lai and U.S. Pat. No. 6,516,821 to Uemura, the entire subject matter of each of which are incorporated herein by reference.

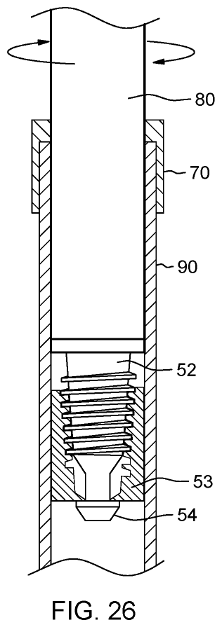

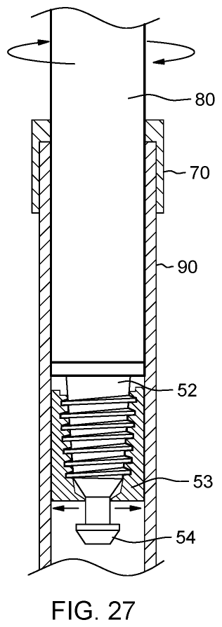

With reference to FIGS. 25-27, one embodiment of the present invention comprises a screw and collar lock 51. Lock 51 may comprise tapered male-threaded member 52 attached to tube 80 and disposed threadably inside female-threaded expandable collar 53 with the threads of the two components meshed. Collar 53 is disposed slidingly within tube 90. Male member 52 may further comprise knob 54 for preventing male member 52 from completely backing out from collar 53 within tube 90. With further reference to FIGS. 26 and 27, when unlocked as in FIG. 26, twisting the tubes causes male-threaded member 52 to advance into female-threaded expandable collar 53 and press the collar outwardly against the inner surface of tube 90, thus locking the tubes together as in FIG. 27. Reversing the process unthreads male member 52 from collar 53 and unlocks the lock. In the unlocked state, tube 80 may slide within tube 90. The collar may be elastically compressed for insertion into outer tube 90 so that it has slight friction with the inside surface of outer tube 90 even when the lock is not engaged, which friction is sufficient to hold the collar in place rotationally as tube 80 and male member 52 rotate. Said slight friction in the unlocked state may be easily overcome by the user to slide tube 80 longitudinally within tube 90 to adjust the length of the pole.

The threads and knob 54 prevent the lock components from separating when tube 80 is slid further out of tube 90. Excessive unthreading may press knob 54 into the end of collar 53 and cause the collar to bulge outward and lock the tubes together less effectively than in the fully threaded state.

In U.S. Pat. No. 6,516,821 to Uemura, the male threaded member is tapered on each end of a middle section and twisting in either direction will cause locking.

“Clutch” telescopic tube locks comprise an internally threaded ‘clutch’ and a split plastic sleeve to tighten and press in on the inside tube when the clutch is turned. “Split collar” telescopic tube locks comprise a split collar that fits around the tubes and a threaded fastener with a knob for hand tightening the collar to clamp the two pole segments tightly together. The split collar may have a portion that conforms with the size of the inner tube with a transition to a portion that conforms with the size of the outer tube so that it may press tightly against both tubes when tightened. “Snap lock” telescopic tube locks comprise snap clamps that clamp the pole segments together. “Set knob” telescopic tube locks comprise a set screw to fix the pole segments together.

All of the foregoing locks may be categorized for purposes of this disclosure as “friction locks” because they operate on the principle of applying mechanical pressure against a surface of one or both of the tubes to create sufficient friction forces to lock in the tubes in position under operable loads. This principle of operation allows the tubes to be locked at any relative position over a continuous range of positions, unlike other types of locks like “spring button” or “retaining pin” locks described below that lock the tubes only at pre-determined incrementally spaced positions.

“Spring button” telescopic tube locks comprise spring buttons that protrude into corresponding holes to lock in the tubes at predetermined positions. Retaining pin with cotter can secure telescopic tube segments with corresponding sets of holes at predetermined increments.

A preferred embodiment of the present invention comprises a friction lock, but other embodiments may comprise any of the foregoing types of locks.

Forces applied on the device in operation propping apart the hind legs of a deer carcass are small. Therefore, the device may be of lightweight construction and may comprise friction locks locking mechanisms for locking the telescoping segments in place. Lightweight construction is desirable for ease of packing and toting on the deer hunt. In a preferred embodiment, the pole segments of the device are of thin-walled lightweight aluminum tubes.

The improved device of the present invention provides a simple, streamlined design with minimal moving parts, minimal protruding features and minimal sharp exterior features for ease of packing, unpacking and using the device. Less streamlined design could cause the device to get hung up on or entangled with other items during packing, unpacking and use. In a preferred embodiment, the device of the present invention is without chains, ropes or other types of lines for hanging such as those that a hanging gambrel comprises.

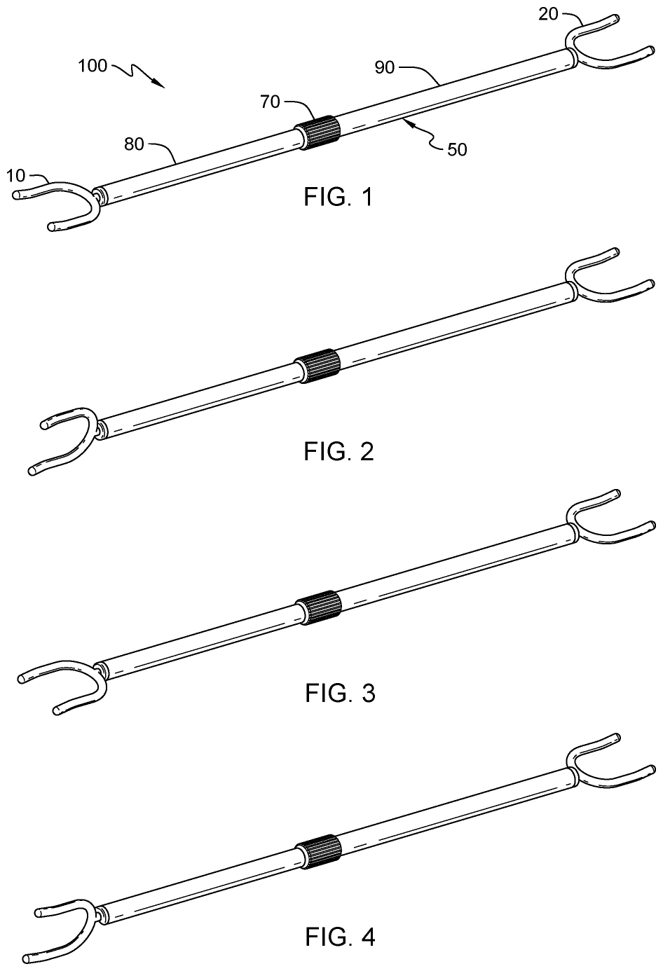

With reference to FIGS. 1-4, forks 10 and 20 may be adjusted through 360° of rotation about the pole axis. FIGS. 1-4 each show example rotational adjustments with FIG. 1 showing the forks rotationally aligned, FIG. 2 showing them offset 90° in one rotational direction, FIG. 3 showing them offset 180° in the same rotational direction, and FIG. 4 showing them offset 270° in the same rotational direction. In a preferred embodiment, such rotational adjustment of the forks relative to one another may be accomplished by one or combination of the following operations: twisting tube segments 80 and 90 relative to one another, by twisting at least one end plug relative to its corresponding tube segment, or twisting at least one fork relative to its corresponding end plug.

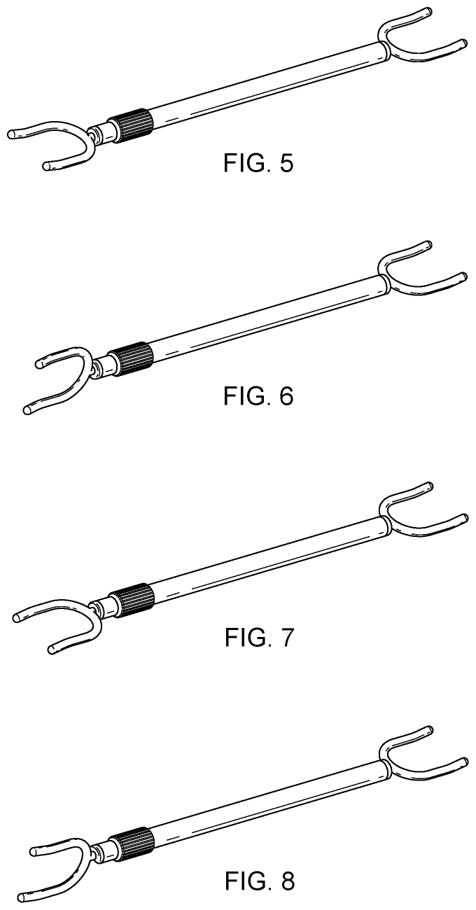

With further reference to FIGS. 1-4, pole 50 is fully extended with pole segment 80 extended longitudinally outward from pole segment 90 to the maximum extent. With reference to FIGS. 5-8, pole 50 is fully retracted with pole segment 80 extended longitudinally outward from pole segment 90 to the minimum extent. Pole segment 80 may slide to any position on the continuum from fully extended to fully retracted and may be locked into position by engaging lock 51 anywhere on the continuum.

With further reference to FIGS. 5-8, the forks 10 and 20 may be adjusted through 360° of rotation about the pole axis in the like manner as described above with reference to FIGS. 1-4.

With reference to FIG. 9, device 100 is deployed in the field, propping open the hindlegs of a deer carcass. Fork 10 is engaged with one hind leg and fork 20 is engaged with the other hind leg. The length of the device may be adjusted as needed to achieve any amount of spread between the legs that the user may prefer. The device may engage any part of a leg that fits between the prongs of the forks. One fork may engage the same anatomical leg feature as the other fork and may engage a different anatomical leg feature as the other fork as the user may prefer.

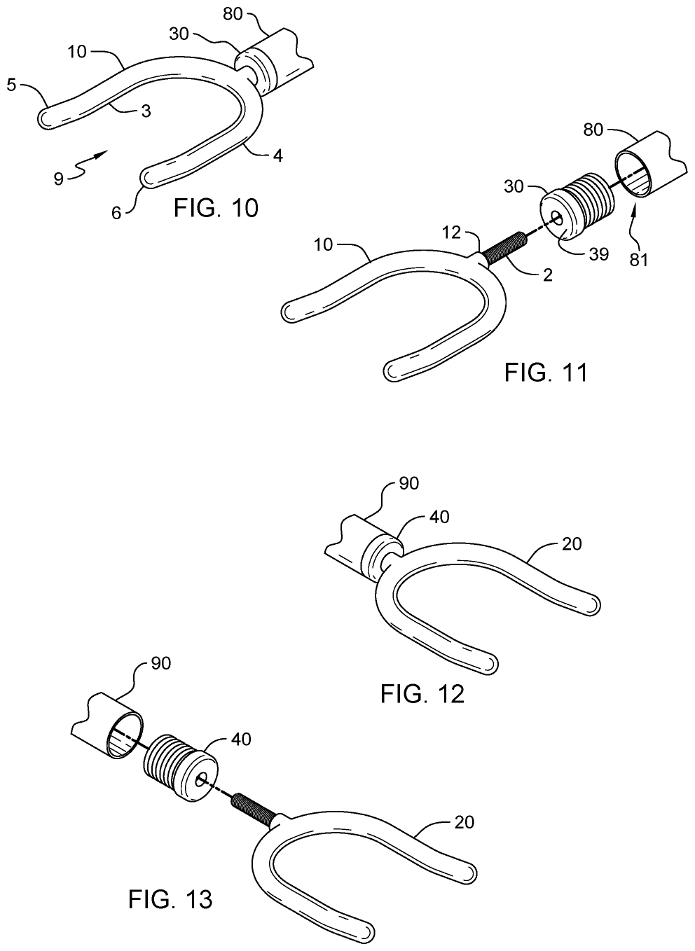

With reference to FIGS. 10 and 20, fork 20 comprises a body 1 and a connector shaft 2 extending longitudinally from the body, said shaft comprising a proximal portion proximal to the body and a distal end distal to the body. Said body comprises prong 3 and prong 4, said prongs forming opening 9 for receiving a deer leg. End portions 5 and 6 of prongs 3 and 4, respectively, may be slightly upturned. Body 1 may comprise main structural element 7 and coating 8. Coating 8 may comprise material that enhances grip, adhesion and tack on the deer leg and may comprise polymer material, rubber, plastic, silicon, vinyl, epoxy, latex or nylon. Coating 8 may be soft, may be hard and may comprise surface texture to enhance grip.

In a preferred embodiment, prongs 3 and 4 may extend a sufficient distance radially outward from the longitudinal axis of the pole so that the overall width of the fork from prong to prong is wider than the outside diameter is of pole segments 80 and 90 and knurl 70. Such a fork width provides utility for engaging a deer leg and prevents the device from rolling away when placed on an inclined surface. The upward turning of the end portions of the prongs provide similar utility.

In one embodiment, shaft 2 may have a uniform cylindrical outer surface. Alternatively, in a preferred embodiment, shaft 2 may comprise male screw threads 11. In a preferred embodiment, said threads may be M6 International Organization for Standardization (ISO) metric screw threads.

With reference to FIGS. 11 and 14-17, device 100 may comprise end plug 30 inserted in the end of tube 80. End plug 30 may comprise ribs 33 and 34 for press outwardly against the inside surface of tube 80 so as to hold end plug 30 securely in place by friction force when inserted into the tube. Ribs 33 and 34 may comprise a disk shape with round outer surfaces conformed to the size and shape of the cylindrical inner surface of tube segment 80. Rib 34 may comprise a beveled edge 39 for ease of insertion into the tube. Ribs 33 and 34 may comprise flexible polymer material, rubber, plastic, silicon, vinyl, epoxy, latex or nylon that may deform elastically in bending and compression upon insertion into tube opening 81.

End plug 40 (FIGS. 12 and 13) may be the same as end plug 30, but sized to fit the larger inside diameter of tube 90.

In a preferred embodiment, end plugs 30 and 40 (FIG. 13) may be held in place by friction forces between the plug and the tube wall, which forces may in one embodiment be sufficient enough to secure the plug in place against forces throughout the range of anticipated forces that may be experienced in operation, while at the same time permitting intentional twisting of the plug within its corresponding tube by exertion of sufficient force by hand to adjust the angular orientation. In another embodiment, the end plug may be even more securely attached to its corresponding tube by means such as greater friction, adhesive, crimping, or any other suitable means.

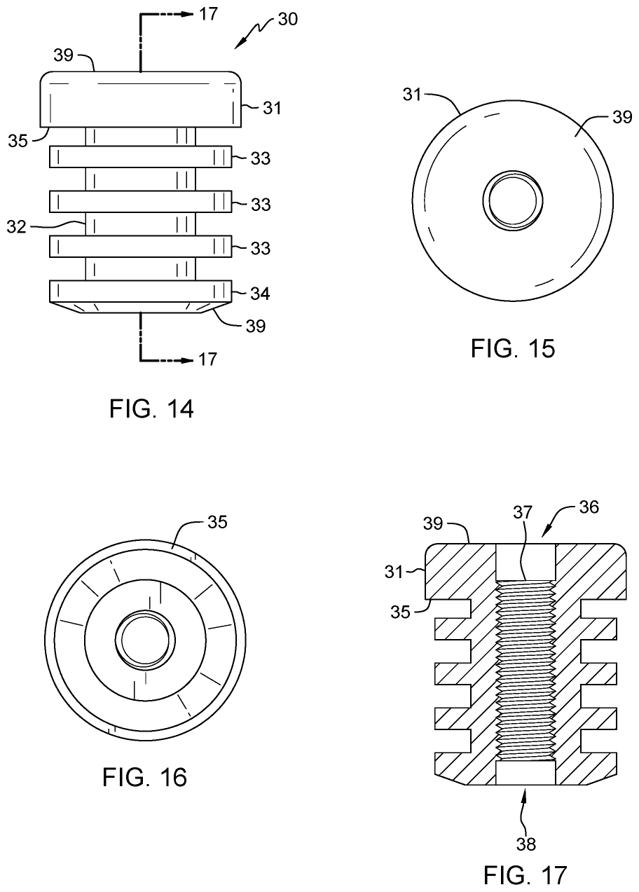

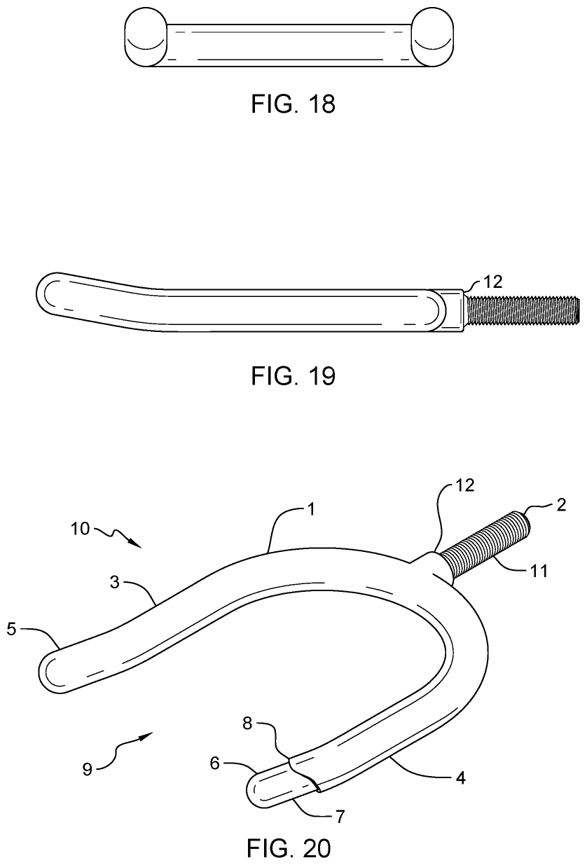

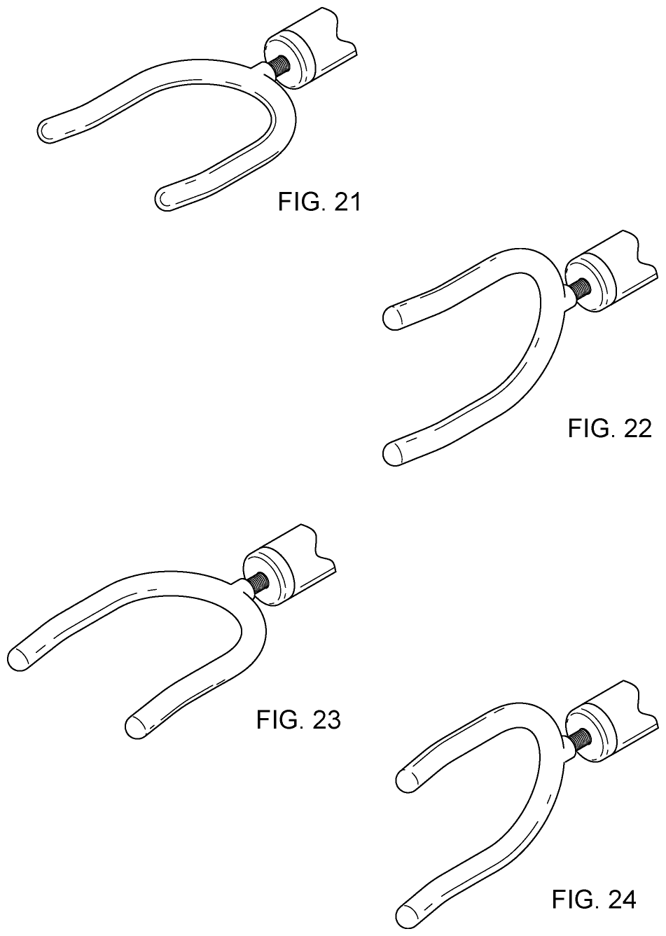

With further reference to FIGS. 14-17, end plug 30 may comprise head 31 for butting against the end of tube section 80 and providing a mechanical stop from further insertion of the head into the tube. Head 31 may have round shape with an outside diameter at least as large as the outside diameter of tube segment 80. The head may have shoulder surface 35 for abutting the end of tube segment 80. The plug may comprise opening 36 aligned on a central longitudinal axis for receiving shaft 2 of fork 10. The head may comprise female screw threads 37 compatible with screw threads 11 of shaft 2.

In a preferred embodiment, the end plug 30 may comprise flexible polymer material, rubber, plastic, silicon, vinyl, epoxy, latex or nylon with a cylindrical insert centered on a longitudinal axis and having screw threads 37 therein. Said insert may be made of metal. The insert may be connected to the end plug by any suitable connection, such as adhesive or press-fit connection.

With reference to FIGS. 11, 14-17, 19 and 20, in an embodiment in which fork shaft 2 comprises right-hand male threads 11 and plug 30 comprises right-hand female threads 37, fork 10 may be releasably threaded into head 30 over a range of extents from a least threaded extent where the leading male threads make first engagement with the leading female threads to a fully tightened extent where body 1 of fork 10 is compressed tightly against head 31 of plug 30. In a preferred embodiment, the fully tightened extent is hand tight and is releasable by applying unthreading force by hand. In a preferred embodiment, the fork body comprises shoulder surface 12 for mating with surface 39 of head 31 of plug 30 when the fork is fully tightened to the plug.

Threading the fork into the plug requires very little torsional force. When the fork is threaded into the plug to an extent between least threaded and fully threaded, torsional force applied by hand to engage lock 51 easily overcomes the force required to thread or unthread the fork from the plug. To employ the device, the forks may be first engaged with the legs, the tube length may be adjusted and the tube segments twisted to engage a twist-lock. The forks may rotate relative to the tube segments as the tube segments are twisted so that the forks maintain their initial orientation relative to the deer legs.

In alternate embodiments, the end plug may comprise a longitudinal smooth-walled bore hole centered on a longitudinal axis for receiving a fork shaft. Said fork shaft may comprise a smooth cylindrical shaft that may be pushed longitudinally into the bore. The diameter of the fork shaft may be selected to achieve the desired fit inside the bore hole, said fit being in the range between a snug fit where the shaft and bore wall press against each other and a loose fit where there is radial clearance between the shaft and bore wall. In a preferred embodiment, the shaft may comprise rigid material such as metal and the bore wall may comprise compliant material such as compliant polymer material or rubber. In one of a snug-fit embodiment, the fit may be tight enough to hold the fork in stable alignment during transportation and handling while allowing the fork to be turnable about the longitudinal axis with moderate force applied by hand. In one embodiment the distal end of the shaft may comprise an enlarged end-boss to prevent the shaft from escaping the bore hole during handling.

In a preferred embodiment, tube segment 90 may have an outside diameter in the range of ½″ to ⅝″, ⅝″ to ¾″, ¾″ to ⅞″, ⅞″ to 1″, 1″ to 1⅛″, 1⅛″ to 1¼″, 1¼″ to 1⅜″, or 1⅜″ to 1½″ and a wall thickness in the range of 0.03″ to 0.06″; and tube segment 80 may have an outside diameter in the range of ⅜″ to ½″, ½″ to ⅝″, ⅝″ to ¾″, ¾″ to ⅞″, ⅞″ to 1″, 1″ to 1⅛″, 1⅛″ to 1¼″, or 1¼″ to 1⅜″, respectively and a wall thickness in the range of 0.03″ to 0.06″. Aluminum poles having dimensions of the foregoing ranges are light weight, yet strong enough to carry operational loads and are durable enough to withstand rough handling typical of a deer hunt.

In a preferred embodiment, tube segment 90 may have a length in the range of 10″ to 11″, 11″ to 12″, 12″ to 13″, 13″ to 14″, 14″ to 15″, 15″ to 16″, 16″ to 17″, 17″ to 18″, 18″ to 19″, 19″ to 20″ or 20″ to 24″, and tube segment 80 may have a length in the range of 10″ to 11″, 11″ to 12″, 12″ to 13″, 13″ to 14″, 14″ to 15″, 15″ to 16″, 16″ to 17″, 17″ to 18″, 18″ to 19″, 19″ to 20″ or 20″ to 24″.

In another preferred embodiment, tube segment 90 may have a length of about 18″, an outside diameter of about 1″ and a wall thickness of about 0.038″; and tube segment 80 may have a length of about 17″, an outside diameter of about ⅞″ and a wall thickness of about 0.038″.

The present invention further provides an improved method of propping apart the hind legs of a deer carcass for field dressing the carcass, comprising the steps of: dispose a device of the present invention between the legs; engage a first end of the device with one leg; engage a second end the device with the other leg; telescopically adjust the length of the device to a first length anywhere on a continuum of lengths; and engage a lock to releasably lock the device at said first length. The adjusting step may comprise extending the length. The step of engaging a first end may further comprise disposing the one leg between two prongs of a first fork. The step of engaging a second end may further comprise disposing the one leg between two prongs of a second fork. The method may comprise telescopically adjusting the length, then engaging a lock. The method may further comprise the step of field dressing the carcass after releasably locking the device at said first length. The method may further comprise the steps of disengaging the lock and retracting the length. The step of engaging a lock may comprise twisting a first segment of the device relative to a second segment of the device.

The steps in the methods have no order limitation unless expressly recited or implicitly required.

While the invention has been particularly shown and described with reference to certain embodiments, it will be understood by those skilled in the art that various changes in form and details may be made to the invention without departing from the spirit and scope of the invention as described in the following claims.

We claim:

1. A deer field dressing device for propping apart the hind legs of a deer carcass, comprising:
a telescopic extension pole having a first end and a second end;
a first fork attached to the first end, said first fork comprising a first prong and second prong for receiving a deer carcass leg between the first and second prongs;
a second fork attached to the second end, said second fork comprising a third prong and fourth prong for receiving a deer carcass leg between the third and fourth prongs.

2. The field dressing device of claim 1, further comprising:
a first rotatable connection between the first fork and first end so that the first fork is rotatably about a longitudinal axis.

3. The field dressing device of claim 2, further comprising:
a second rotatable connection between the second fork and second end so that the second fork is rotatably about the longitudinal axis.

4. The field dressing device of claim 2, wherein the first rotatable connection is a threaded connection.

5. The field dressing device of claim 3, wherein the second rotatable connection is a threaded connection.

6. The field dressing device of claim 1, wherein the first fork comprises a thin surface coating.

7. The field dressing device of claim 1, wherein:
the first fork comprises a longitudinally aligned first shaft;
the first end of the extension pole comprises a longitudinally aligned first hole for receiving the first shaft; and
the first shaft is disposed in the first hole so that the first fork is rotatable about a longitudinal axis.

8. The field dressing device of claim 5, wherein:
the second fork comprises a longitudinally aligned second shaft;
the second end of the extension pole comprises a longitudinally aligned second hole for receiving the second shaft; and
the second shaft is disposed in the second hole so that the second fork is rotatable about a longitudinal axis.

9. The field dressing device of claim 7, wherein:
the first shaft comprises male threads;
the first hole comprises female threads; and
the first shaft is threaded in the first hole so as to form a first threaded connection.

10. The field dressing device of claim 8, wherein:
the second shaft comprises male threads;
the second hole comprises female threads; and
the second shaft is threaded in the second hole so as to form a second threaded connection.

11. The field dressing device of claim 1, wherein:
the pole comprises a first pole segment, a second pole segment, and a releasable lock for releasably locking the first pole segment and second pole segment together;
the first pole segment comprises a first hollow tube;
the second pole segment comprises a second hollow tube longitudinally aligned with and slidingly disposed in the first hollow tube;
the second pole segment slidable to any position on a continuum of positions from a retracted position to an extended position;
the second pole segment and first pole segment are releasably lockable to each other in any position on the continuum of positions.

12. The field dressing device of claim 11, wherein:
the lock is disposed inside the first pole segment.

13. The field dressing device of claim 12, wherein:
the lock is engageable by twisting the first pole segment about a longitudinal axis relative to the second pole segment.

14. A method of propping apart the hind legs of a deer carcass for field dressing purposes, comprising the steps of:
dispose between the hind legs of the carcass a telescopic extension pole having a first end, a second end, a releasable friction lock, and an adjustable length adjustable to any length on a continuum of lengths from a fully retracted length to a fully extended length;
engage a first end of the device with one hind leg;
engage a second end the device with the other hind leg;
adjust the length to a first length anywhere on the continuum; and
releasably lock the friction lock to releasably fix the length of the extension pole at the first length.
